(19) United States
(12) Patent Application Publication
(10) Pub. No.: US 2025/0190536 A1
(43) Pub. Date: Jun. 12, 2025

(54) APPLICATION IDENTIFICATION

(71) Applicant: Microsoft Technology Licensing, LLC, Redmond, WA (US)

(72) Inventors: Gal Asher SHACHOR, Yokneam Ilit (IL); Meir Baruch BLACHMAN, Jerusalem (IL); Nesia AVIVI, Modiin (IL); Michael SHALOM, Petah Tikva (IL); Adi YASKOLKA WEISS, Herzliya (IL); Tomer CHERNI, Gany Tikva (IL)

(21) Appl. No.: 18/400,471

(22) Filed: Dec. 29, 2023

Related U.S. Application Data
(60) Provisional application No. 63/608,143, filed on Dec. 8, 2023.

(51) Int. Cl. G06F 21/44

(52) U.S. Cl. CPC G06F 21/44

(57) ABSTRACT

A method for verifying an application structured to execute on a client device. A challenge request is sent to the application. A candidate challenge answer is received from the application in response to the challenge request, which is then provided as input to a verification computation with a challenge input. Based on an output of the verification computation, it is determined that the candidate challenge answer is generated by providing the challenge input to a challenge computation. Based on the determination that the candidate challenge answer is generated by providing the challenge input to the challenge computation, the application is verified.

### CROSS-REFERENCE TO RELATED APPLICATION

This application claims priority to U.S. Provisional Patent Application No. 63,608,143, entitled “APPLICATION IDENTIFICATION,” filed on Dec. 8, 2023, the disclosure of which is incorporated herein by reference in its entirety.

### TECHNICAL FIELD

The present disclosure relates to identifying an application executed on a client device, and in particular a web browser.

### BACKGROUND

Local applications, executed on client devices, are required to identify themselves to a remote application or server in order to perform certain functions. For example, a web browser sends an HTTP request to a server to access a resource of the server. An application associated with the resource may make a similar request when attempting to access a user profile or other features provided by the server. In another example, an application sends a bid request for displaying advertisements in the application, which indicates the type of application and its user.

During the identification, or authentication, process, the application provides data which pertains to its identity. However, applications are able to spoof this data, allowing a malicious application to pose as an authorized application, thereby enabling functionality for which the malicious application is unauthorized. This may be referred to as application spoofing. In the specific example of a web browser, this is referred to as browser spoofing.

One known reason for authenticating an application is to ensure that predefined security policies are enforced. The ability to define and enforce policies is a cornerstone of modern enterprise-grade security. A policy is a collection of rules that govern access to data, data, systems or services and the like in a given context. For example, a policy may restrict or block access to certain websites or domains, or restrict certain operations (such as file download or uploads, file modification or deletion, file sharing operations, access to or usage of peripheral devices such as cameras or printers, clipboard copy actions etc.). Herein, a policy is said to be ‘executed’ when the policy rules are evaluated on a given set of contextual inputs. A policy may, for example, be defined or customized by an organization, and applied or enforced in relation to infrastructure, services etc. within an organization domain.

Policies can be deployed and enforced in a variety of situations. For example, in the case of network traffic routed through a proxy service, a policy may be executed at the proxy service to determine whether to block or allow a request received at the proxy service. As another example, in a cloud computing context, a policy may be executed in a back-end cloud computing system, e.g. to determine whether to block or allow an access attempt to a cloud service, or to determine whether to allow or permit a more granular action in relation to a cloud service (such as accessing, modifying, downloading or uploading a document or other data, e.g. whether to permit certain data to be copied to a clipboard). As another example, so-called “enterprise” browsers are equipped with a policy engine to enable local policy execution and enforcement at a client device in relation to web applications accessed via the enterprise browser. In this final example, it is important to ensure the identity of the browser.

### SUMMARY

A mechanism for verifying an application is provided herein. A verifier sends a challenge to the application. In response, the application computes a challenge answer, based on a challenge computation known to the application. The challenge answer is then sent from the application to the verifier for verifying.

If the application is able to correctly compute the challenge answer, the verifier can be assured that the application is of a required type. This helps prevent application spoofing, in which the application attempts to pass off as another application, thereby enabling the application to access functionality or data that it would otherwise be unauthorized and unable to access.

The methods provided herein may, therefore, be considered application anti-spoofing methods.

In one particular implementation, the application is a web browser. Ensuring the browser is of the required type, and in this case an enterprise browser, enables policies to be enforced.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 shows a known federated authentication flow;

FIG. 2 provides an example method for executing a browser verification;

FIG. 3 provides another example method for executing a browser verification;

FIG. 4 schematically illustrates an example challenge request;

FIG. 5 schematically illustrates an example an example challenge response;

FIGS. 6A and 6B schematically illustrate a challenge computation and corresponding verification computation comprising hash functions;

FIGS. 7A and 7B schematically illustrate a challenge computation and corresponding verification computation comprising encryption and decryption functions respectively;

FIGS. 8A and 8B schematically illustrate a second challenge computation and corresponding verification computation comprising encryption and decryption functions respectively;

FIG. 9 illustrates a method by which a malicious users may obtain sensitive information using an automation tool;

FIG. 10 illustrates an example method for rejecting a browser driven by an automation tool;

FIG. 11 illustrates an example method for disabling devtools; and

FIG. 12 shows a schematic block diagram of an example computer system.

### DETAILED DESCRIPTION

When requesting access to resources executed on, or provided by, a server, an application executed on a client device identifies itself to the server. The application is required to provide data pertaining to its identity, such as an application identifier and version.

One example of application authentication is federated authentication. Federated authentication is used to enable a user to authenticate themselves and thereby access an application. During this process, a browser, through with the user is accessing the application, is also verified.

Federated authentication is provided herein by way of example only, and it will be understood that the principles of the methods described herein may extend to other implementations in which an application executed on a client device is required to authenticate its identity to a server or other remote service.

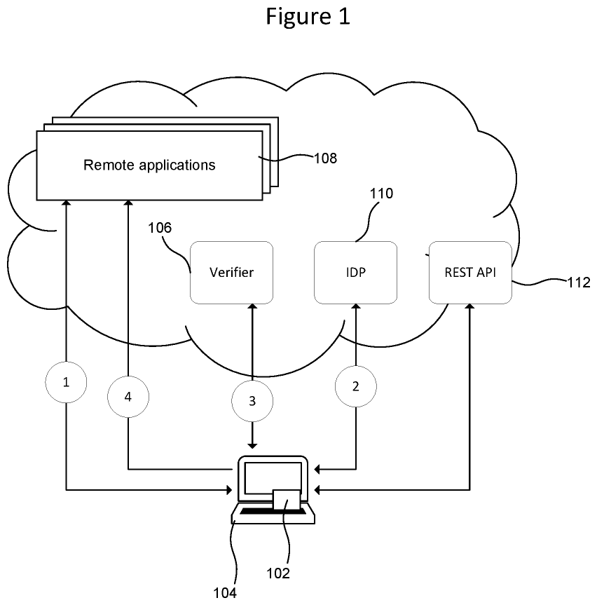

FIG. 1 shows a schematic block diagram of an example networked system in which a known federated authentication is being executing, comprising a client device 104, a local application verifier 106, an identity provider (IDP) 110, a policy execution application program interface (API) 112, and or more remote applications 108.

At the client device 104, the remote applications 108 (remote from the client device 104), such as web applications, cloud services etc., are accessed via the local application 102 (e.g., web browser). In other implementations, multiple local applications may be installed on the client device 104, via which different remote applications are accessed.

The local application 102, such as a web browser, is shown executed on the client device 104. Although not shown in FIG. 1, the client device 104 comprises at least one processor programmed or otherwise configured to carry out the described functions of the client device 104 and at least one network interface via which the client device 104 can communicate with IDP 110, policy execution API 112, and the remote web applications 108. The local application 102 as exemplified herein is an enterprise browser, which both enables user engagement with the remote web applications 108 and applies policies.

The client device 102 communicates with the remote applications 108, IDP 110, and policy execution API 112 via a network, such as the public Internet.

The IDP 110 integrates with the remote applications 108 to authenticate users. The IDP 110 may authenticate a user by, for example, receiving a user identifier and password associated with an user account registered to the user at the remote application 108, and verifying that the user identifier and password match those associated with the account. Other user authentications methods are known, such as browser to we single sign-on (SSO).

The local application verifier 106 verifies the local application 102. It also integrates with the IDP 110 to enforce access policies of an access policy service. This verifier 106 also equips the local application 102 with the policies.

The policy execution API 112 is a backend service comprising Representational state transfer (REST) APIs for supporting the policy execution at the local application 102.

During known authentication, the following steps are performed:
1. the user, via the client device 104, access the remote application 108 using the local application (web browser) 102. The remote application 108 determines that there is no session cookie, and as result redirects the browser 104 to the IDP 110 for authentication.
2. The IDP 110 authenticates the user, and redirects the browser 106 to the browser verifier 106.
3. The browser verifier 106 validates that the browser 102 is of the required type, or version, and prepares a token and list of policies that the browser 102 should enforces for the remote application 108 and user.
4. The browser verifier 106 redirects the browser 102 to the remote application 108 and provides the browser 102 with:
   a. Token that can be used when calling back to the access policy server; and
   b. Policies for the browser 102 to enforce on the remote application 108.

In step 3, when the browser 102 is verified, the browser 102 automatically sends to the browser verifier 106 a user-agent header. The user-agent header allows the browser type to be identified.

As set out above, the policies are enforced due to the browser being of a predefined type, here an enterprise browser. Therefore, it is important to identify that the browser 102 is an enterprise browser with strong assurance.

However, in the browser verification step set out above, step 3 of FIG. 1, it is possible for a malicious user to falsely identify the type of browser because the user-agent header used to verify the browser type is easy to modify or replace. This is referred to as browser spoofing. Thus, the method of verifying the browser 102 is not reliable for security.

Herein is provided a modified authentication method which more reliably identifies the type of browser. In this method, step 3 set out above is modified.

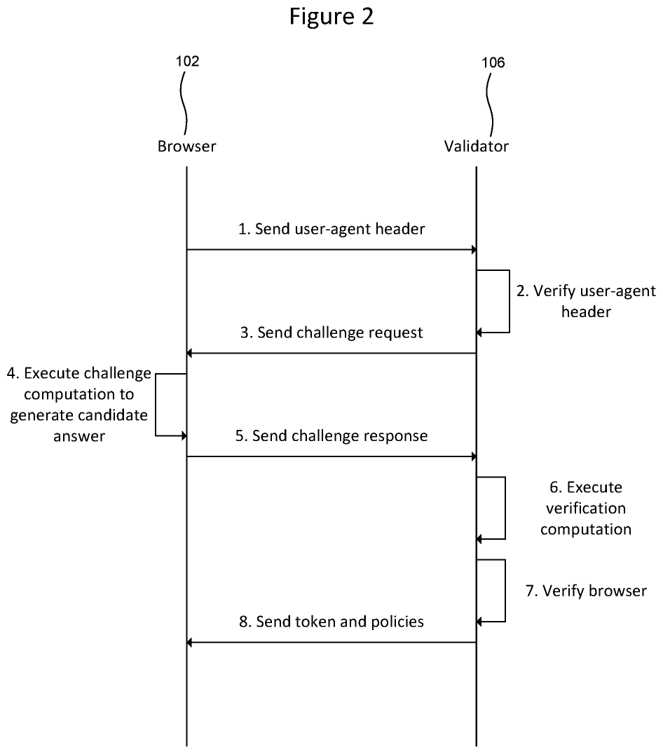

FIG. 2 provides a modified browser verification method.

At step 1, the browser 102 sends the user-agent header to the validator 106 for verifying, as discussed above and implemented in known authentication flows.

The validator 106 verifies that the user-agent header corresponds to the required browser type, step 2, and in response sends a challenge request to the browser, step 3. The challenge request is described in more detail below. In summary, the challenge request causes the browser 102 to execute a corresponding challenge computation to generate a challenge answer, which can be used to verify that the browser 102 is of the required type.

At step 4, the browser executes the challenge computation, in response to receiving the challenge request, to generate a candidate challenge answer. The candidate challenge answer is generated by providing a challenge input to the challenge computation.

At step 5, the browser 102 sends a challenge response comprising the candidate challenge answer to the verifier 106.

Once received, the verifier 106 provides the candidate challenge answer and challenge inputs to a verification computation, step 6, to determine if the candidate challenge answer has been correctly generated. if the challenge candidate answer is correctly generated, the validator 106 verifies the browser 102 as being of the required type, step 7. Once the browser is verified, the validator 106 sends the browser 102 the token and policies, step 8, such that the browser 102 can provide the remote application 108 to the user while implementing the policies.

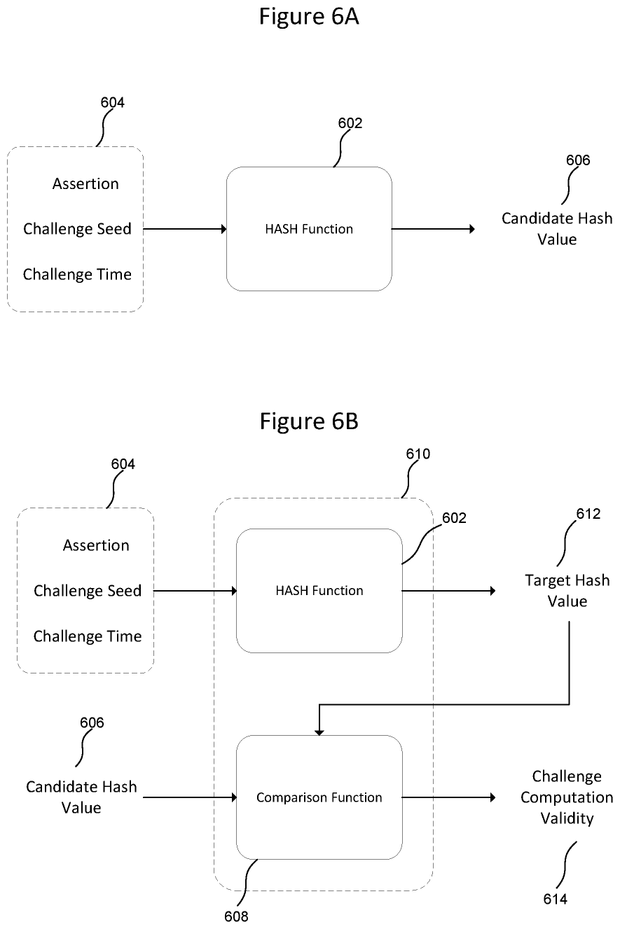

Various methods for computing the candidate challenge answer and the corresponding verification method can be used. Some examples are described with reference to FIGS. 6 to 9 below. In essence, the challenge answer is generated in such a way that it can only be generated by a browser of the required type. For example, the challenge computation may be encoded in browser of the required type. Alternatively or additionally, the challenge input may comprise information which can only be known or derived by a browser of the required type. The challenge answer may also be derived from time related data, such that a malicious entity cannot use an intercepted challenge response to falsely verify itself as the required browser type.

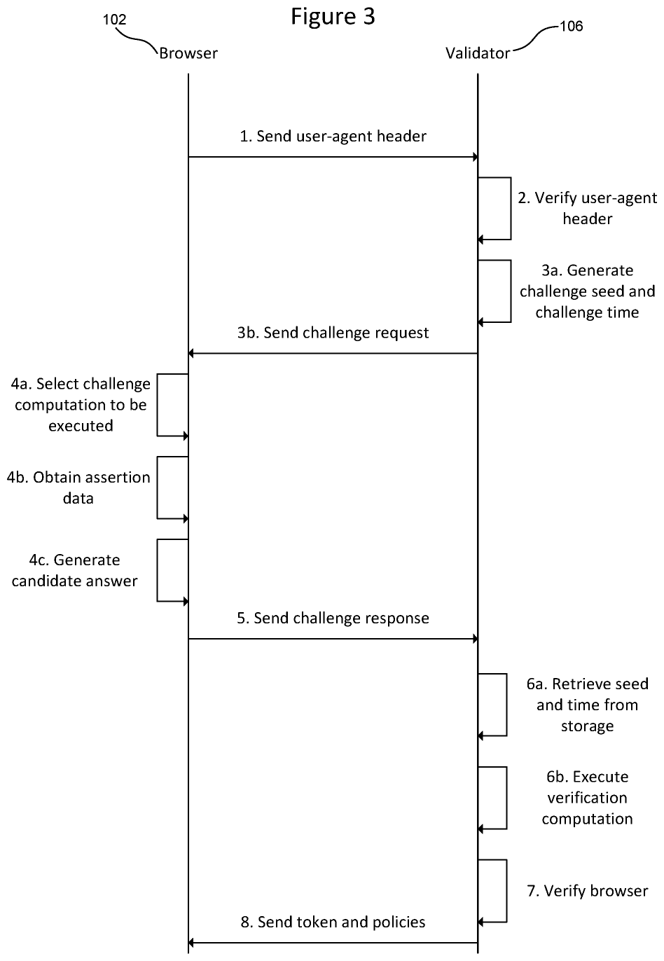

FIG. 3 provides a modified method for verifying the browser 102. Steps 1 and 2 are as described in FIG. 2.

At step 3a, the verifier 106 generates a challenge seed and challenge time, which are sent to the browser 102 in the challenge request, step 3b. The challenge request may also comprise a challenge computation indicator. The validator 106 stores the challenge seed and challenge time in storage accessible thereto for later retrieval. The validator 106 also stores the challenge computation indicator.

At step 4a, the browser 102 selects the challenge computation to be executed. For example, the browser 102 may have encoded multiple challenge computations. The challenge computation selection may be based on the challenge computation indicator of the challenge request, if included, where each encoded challenge computation is associated with a challenge computation identifier. The selection may be based on the validator 106 from which the request is received, that is there may be multiple validators, each associated with a respective challenge computation. Alternatively, there may only be a single encoded challenge computation, wherein the challenge computation is selected in response to receiving the challenge request.

The browser 102 obtains assertion data at step 4b. Assertion data is data which the browser 102 claims to be true, and can be proven to be true by verifying the challenge answer. Herein, assertion data refers to data which defines a context of the browser 102. The assertion data which may be included in described with reference to FIG. 5 below.

At step 4c, the browser 102 computes the candidate challenge answer. The challenge inputs comprise the assertion, the challenge seed, and the challenge time.

Each of the challenge inputs contribute to the assurance of the verification of the browser. By including a challenge time, the challenge response becomes invalid if provided to the verifier 106 after a delay which is above a threshold. Therefore, an intercepted challenge response cannot be used by a malicious used for browser spoofing, that is a replay attack is prevented.

The challenge seed can provide similar protection against replay attacks. For example, the validator 106 may generate a new challenge seed for each challenge request. Thus, any browser 102 returning a candidate challenge answer generated using a challenge seed which was provided in a different challenge request is not verified.

The assertion data, defining the context of the browser 102, can be used to determine if defined browser criteria are met. These criteria may be required for implementing one or more of the policies.

It will be appreciated that the challenge input data may comprise one or more of these elements. Other inputs may be used, as would be apparent to the skilled person.

At step 5, the browser 102 sends the challenge response to the validator 106. The challenge response comprises the candidate challenge answer and the assertion data.

The validator, at step 6a, retrieves the challenge seed and challenge time from storage in response to receiving the challenge response. These are then provided as inputs to the verification computation, together with the candidate challenge answer, at step 6b.

Based on the output of the verification competition indicating that the target challenge answer was correctly computed, the validator 106 verifies the browser 102 at step 7, and sends the token and policies to the browser 102 at step 8.

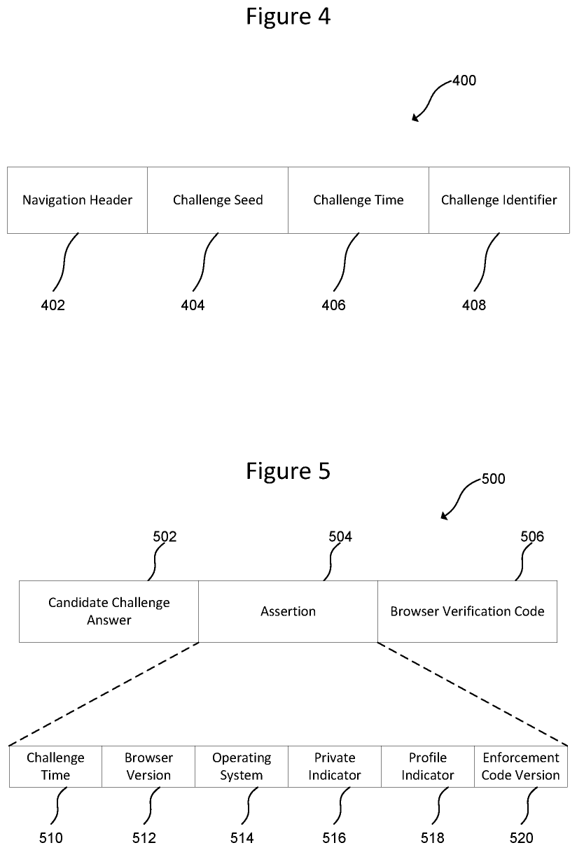

FIG. 4 provides an example challenge request 400 sent from a verifier 106 to a browser 102. The challenge request 400 comprises a navigation header 402, a challenge seed portion 404, a challenge time portion 406, and a challenge identifier portion 408.

The navigation header 402 is HTML content which causes the challenge response to automatically navigate back to the validator 106.

The challenge seed portion 404 is an HTTP header comprising the challenge seed value which is provided as part of the challenge input. The seed value is a long, random, string.

The challenge time portion 406 is an HTTP header comprising the challenge time. The challenge time specified the time of the challenge. A challenge answer cannot extend beyond a configured interval from the challenge time and remain valid.

The challenge identifier portion 408 is an HTTP header comprising the challenge computation indicator. The challenge computation indicator is used by the browser 102 to select between the possible challenge computations that are encoded at the browser.

FIG. 5 provides an example challenge response 500 generated by the browser 102. The challenge response 500 comprises three HTTP headers: a candidate answer header 502 comprising the candidate answer, an assertion header 504 comprising the assertion data, and a browser verification code header comprising the version of the browser verification code used.

The candidate challenge answer may be referred to as a cryptographic answer.

The assertion data comprises the challenge time 510, a browser version string 512, an operating system version string 514, a private indicator 516, a profile indicator 518, and an enforcement code version 520. The private indicator 516 is set to 1 if the browser 102 is in private mode, and 0 otherwise. The profile indicator is set to 1 if the user profile being run on the browser is a work profile, and 0 otherwise. The enforcement code version 520 is a version string of the enforcement code of the browser 102. In some embodiments, the challenge time 510 forms part of the challenge response 500 but is not a component of the assertion data.

The challenge time is measured in milliseconds since epoch or the time string of the challenge request 400. The challenge time 510 included in the challenge response 500 may be the challenge time received in the challenge request 400. Alternatively, the challenge time 510 may be a time since the challenge time of the challenge request 400, or an absolute time at which the challenge response 500 is generated or assertion data obtained.

The assertion data is used by the verifier 106 to determine if the browser 102 satisfied requirements for implementing security policies. It is provided as input to the verification computation to check that the browser 102 has derived the candidate challenge answer from the assertion data, and therefore that the assertion data corresponds to the browser 102.

In the above example, there is a requirement for a user profile to be a work profile, i.e. that the profile indicator is set to 1 for work profiles only. It will appreciated that other profile types may be defined to be relevant or not (and therefore set to 1 or 0 respectively) in the context of the implementation of the method provided herein.

In the example provided herein, there is a requirement for a browser to be run in a public mode. This is due to privacy requirements. Specifically, in implementation of the method provided herein, the verifier 106 collects audit data from the browser 102, and therefore the browser 102 cannot be executed in a private more.

The verifier 106 checks the assertion data received from the browser 102 to check that application criteria are met. These include, for example, the requirement for the user profile to be a work profile and the browser to be in public mode. The verifier 106 may verify the browser only if the application criteria are met.

The verifier 106 may also check the challenge time 510 received in the challenge response 500. If the challenge time 510 is required to be the same as the challenge time of the challenge request 400, the verifier checks that this is true for the received challenge time 510. The verifier 106 may also check that a current time, at which the challenge response 500 is received, is within a predefined time of the challenge time, thereby determining that the challenge response 500 was generated in response to the challenge input 400 and thus verifying that the challenge response 500 is not part of a replay attack.

If the challenge time 510 of the challenge response 500 is required to represent the time of the assertion data or challenge response 500 instead, the verifier checks that an elapsed time between the challenge request 400 and challenge response 500 is below a threshold time. This ensures that the challenge response 500 was generated in response to the challenge request 400, that is that the challenger response 500 is not part of a replay attack or part of an attack using an intercepted challenge response 500.

As discussed above, the challenge request 400 comprises a challenge computation indication, or challenge indicator, which is used by the browser 102 to select the challenge computation to execute. The browser 102 comprises logic for selecting the challenge computation, referred to as a challenge selector, and for executing the challenge computation, referred to as challenge handlers. Based on the challenge computation indicator, the challenge handler of the browser 102 knows to answer different challenges by executing different challenge computations. The inputs required for the challenge computation are also known.

FIGS. 6A, 7A, and 8A provide example challenge computations, while FIGS. 6B, 7B, and 8B provide the corresponding verification computations.

FIG. 6A provides a challenge computation comprising a hash function 602, for example a SHA512 hash function. The assertion data, challenge seed, and challenge time are provided as the challenge inputs 604 to the hash function 602. A shared secret, shared between the browser 102 and the verifier 106, may also be provided as input to the hash function 602.

A candidate hash function 606 is computed from the challenge inputs 604 and provided as the candidate challenge answer.

The handler corresponding to the challenge computation in FIG. 6A may be referred to as a hash handler. In the case of the hash function being a SHA512 hash, the handler may be referred to as a SHA512 handler.

To verify the candidate hash function 606, a verification computation 610 comprising the hash function 610 and a comparison function 608 is executed.

The challenge inputs 604 are provided to the hash function 602 to compute a target hash value 612. The target hash value 612 is provide as input to the comparison function with the candidate hash value 606 computed by the browser 102. The comparison function 608 compares the candidate and target hash functions 606, 612 to determine if they are the same, i.e. that the same inputs and hash function has been used to generate the hash values. The output of the comparison function 608 is referred to as a challenge computation validity 614, and indicates if the challenge answer is validly generated.

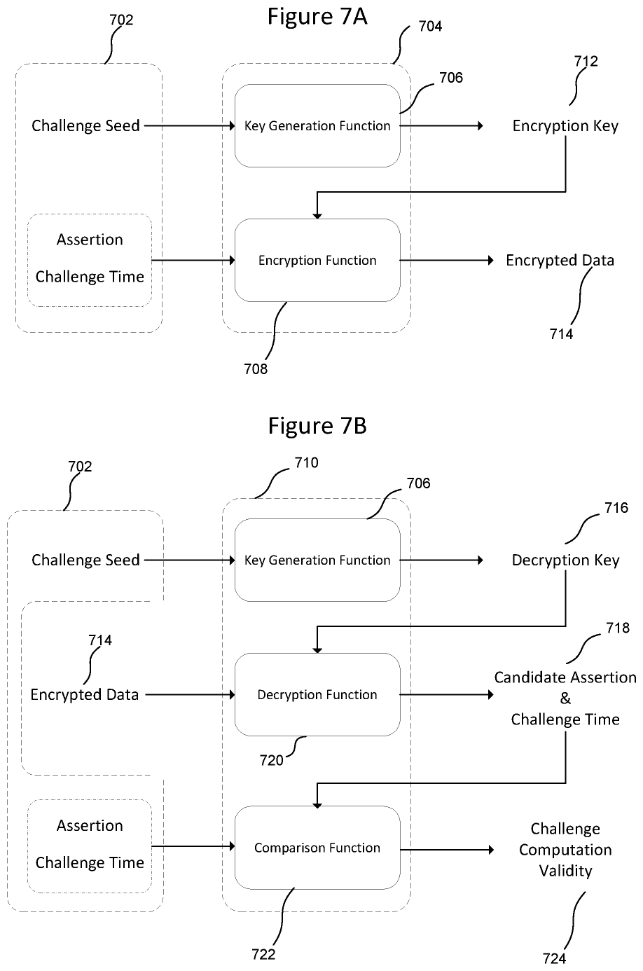

FIG. 7A shows a challenge computation 704 comprising an encryption function 708. The challenge computation 704 also comprises a key generation function 706. The challenge inputs 702, comprising the challenge seed, assertion data, and challenge time, are provided as inputs to the challenge computation 704 to generate the candidate challenge answer, in this case encrypted data 714.

The challenge seed is provided as input to the key generation function 706, which generates therefrom an encryption key 712. The key generation function may be, for example, a PBKDF2 function. The number of PBKDF2 iterations is known to both the browser 102 and the verifier 106.

The generated encryption key 712 is used, by the encryption function 708, to encrypt the assertion data and challenge time, thereby generating the encrypted data 714.

The handler corresponding to the challenge computation provided in FIG. 7A may be referred to as an encryption handler. One example of an encryption handler is a PBKDF2 handler, in the embodiment in which the key generation function is a PBKDF2 function.

FIG. 7B provides the corresponding verification function 710, which comprises the key generation function 706, a decryption function 720, and a comparison function 722. The verification function 710 takes as input the challenge inputs 702 and the encrypted data 714.

The challenge seed is provided as input to the key generation function 706 of the verification function 710 to generate a decryption key 716. Since the key generation function 706 and its input are the same for both the challenge and verification computation 704, 710, the encryption key 712 and the decryption key 716 are equal. These keys 712, 716 are said to be symmetric.

The decryption key 716 is then used by the decryption function 720 to decrypt the encrypted data 714. As a result, candidate decrypted data 718, comprising candidate assertion data and a candidate challenge time, is computed.

The candidate encrypted data 718 is compared, by the comparison function 722, to the assertion data and challenge time used to generate the encrypted data 714. The assertion data used is that which is received in the challenge response 500 from the browser 102, i.e. it is the data the browser 102 claims to be true and claims to have used to generate the candidate challenge answer.

The comparison function 722 outputs an indication of the validity of the challenge competition 724. That is, if the candidate decrypted data 718 matches the data that is claimed to have been used to generate the encrypted data 714, the verifier 106 is assured that the browser 102 correctly generated the encrypted data and therefore meets the browser type requirements.

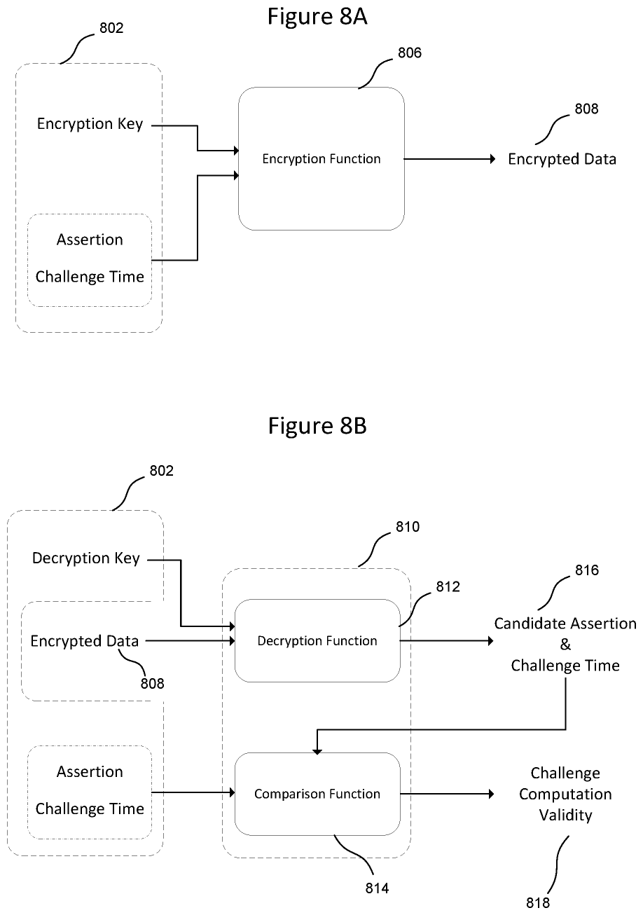

FIG. 8A shows an alternative challenge computation comprising a hash function 806. In this example, the handler may also be referred to as an encryption handler. However, in this example, the encryption key is not generated as part of the challenge computation. Instead, a separately provisioned shared key is used by the encryption function 806 to encrypt the assertion data and the challenge time. As such, the handler may be more specifically referred to as a shared key handler.

In this example, the challenge inputs 802 comprise the encryption key (shared key), the assertion data, and the challenge time. The encryption function 806 encrypts the assertion data and challenge time using the encryption key to generate the candidate challenge answer, in this case encrypted date 808.

The encryption key is provided to the browser 102 by the verifier 106 at some time prior to the challenge request, and stored at the browser 102. Alternatively, the encryption key is encoded in the browser 102 and known to the verifier 106, such that no exchange of the encryption key is required.

FIG. 8B provides the corresponding verification computation 810, comprising a decryption function 812 and a comparison function 814. The verification function takes an inputs the challenge inputs 802, comprising the decryption key, the assertion data, and the challenge time, and the encrypted data 808. It is noted that the encryption key and the decryption key are shared keys and therefore are equal.

The decryption key is stored by the verifier 106 and retrieved for providing as input to the decryption function 812, such that it is used to decrypt the encrypted data 808 to compute candidate decrypted data 816, comprising candidate assertion data and candidate challenge time.

The comparison function 814 compares the candidate decrypted data 816 to the assertion data and challenge time, i.e. the data which the browser 102 claims to have encrypted, and generates an indication of the challenge computation validity 818. As previously discussed, if the candidate decrypted data 816 matches the data that the browser 102 claims to have encrypted, the challenge computation is valid.

It will be appreciated that the challenge and verification computations provided above are provided by way of example only. It can be seen from the above examples that the candidate challenge answer is a cryptographic response.

In the example challenge and verification computations set out above, the challenge time is provided as an input. The challenge time may be the challenge time received in the challenge response 400 from the verifier, or it may be a challenge time generated by the browser 102 defining the time of the challenge response. In some embodiments, the challenge time is not provided as input. In this case, the challenge time may be checked by the verifier 106 as described above to determine that the challenge response 500 is provided within a predefined allowable time window from when the challenge request 400 was sent.

The method set out above increases the difficulty of an attack by a malicious entity as the identity of the browser 102 is assured with higher confidence. In the examples above, the verifier 106 can be assured of the browser environment, or context, and therefore has confidence that the required policies will be executed. In particular, the method above can verify:
The version of the browser.
The version of the policy enforcement code running in the browser.
The operating system hosting the browser.
The context in which the user runs in the browser, e.g., inprivate execution context.

The method provides a balance between security and usability, and allows the verifier 102 to validate the identity of the browser 102 and either accept it and the associated execution context, or reject it. The verifier 102 may form part of a security service, which also includes the policy service, and may further include the IDP 110 and the policy execution API 112. The security service is executed by a security server, which is remote to the client device 104 and accessible via a network such as the Internet.

The browser 102 is rejected if the verifier 106 determines that the candidate challenge answer is not correctly computed. For example, the assertion data used to derive the challenge answer may not match the assertion data provided in the challenge response. In another example, the challenge time used to derive the challenge answer may not match the challenge time in the challenge request. In another example, the challenge computation used to generate the challenge answer may not be the challenge computation as defined in the challenge request. It will be apparent to the skilled person that other ways in which the challenge answer may be invalidly generated are possible.

To summaries, the method integrates with the federated authentication protocol and adds a browser validation phase:
1. During the user's authentication, the browser 102 is challenged by the authenticating servers.
2. The browser 102 receives the challenge and responds (base on the challenge parameters) with a response that the server 106 expects to receive.
3. The server 106 will validate the challenge response and either accept or reject it.

While the browser verification method is provided in the context of federated authentication, it will be appreciated that browser verification as disclosed may be used in any context in which it is desirable to verify browser parameters. Moreover, other types of local application 102 may be verified in this way.

Even if the browser 102 is verified, it is still possible for a malicious entity to bypass security policies and controls. Two known ways in which this may be achieves are automation and embedding.

The browser 102 can be used as an automation tool which can bypass the defined security controls for the browser 102 providing a remote application 108 by leveraging an automation API. This allows a user to try to extract information using brute force and other options that are not possible manually.

The browser 102 can be embedded into an application which can interact with the browser 102 programmatically which would bypass defined session-controls. For example, the application would execute the download activity while the browser 102 is used only to obtain the user's cookies for authentication. The application would extract the cookie from the embedded browser 102.

In a traditional automation flow, such as that set out with reference to FIG. 1 above, the following steps occur:
1. Client device launches the browser 102 with custom command-line-arguments, including but not limited to:
   a. Expose the DevTools protocol via a public port;
   b. Configure a proxy for the network communication;
   c. Configure a custom user-profile for the launched browser.
2. Once the browser 102 is launched, the automation can control the behavior of browser 102 by using DevTools protocol API:
   a. Can control navigations;
   b. Can inject custom JavaScript code;
   c. Can upload files via the DevTools protocol while bypassing traditional upload controls;
   d. Can download files via the DevTools protocol while bypassing traditional upload controls.

By using the above automation flow, a malicious user can bypass most data loss prevention (DLP) and sometimes security controls.

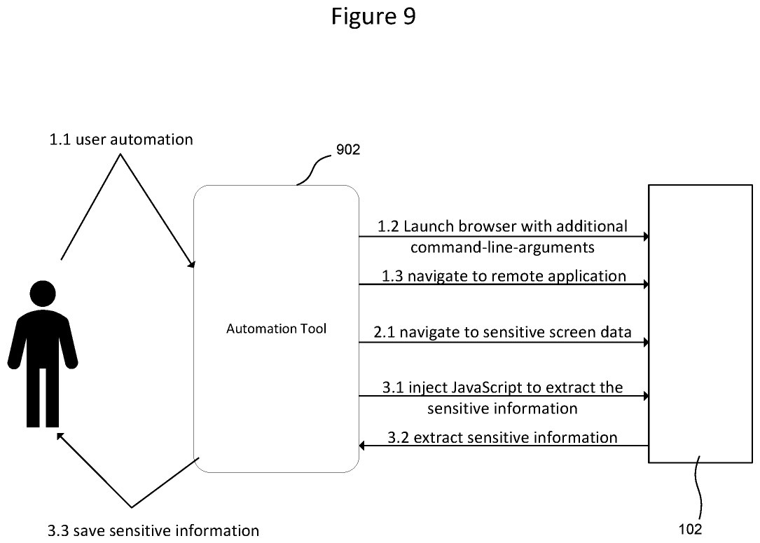

FIG. 9 provides an example method which may be implemented by a malicious user to obtain sensitive information using an automation tool 902.

At step 1.1, the user initiates automation via the automation tool 902, which launches the browser 102 with additional command-line-arguments, step 1.2, and navigates via the browser 102 to the remote application 108, step 1.3, where a user account is logged in to, step 1.4.

The automation tool 902 allows the user to navigate to a sensitive data screen of the remote application 108 via the browser 102 as the automation tool 902 bypasses the security controls, step 2.1.

The automation tool 902 injects a JavaScript into the remote application 108, step 3.1, to extract therefore sensitive information provide on sensitive data screen, step 3.2. The user can then save the sensitive data, step 3.3.

To prevent such access to, and retrieval of, sensitive information, methods are provided herein to detect embedders and automations, and disable developer-tool (devtool) protocols running in the enterprise browser 102.

In summary, the browser 102 provides context when a request is issued to the access-control service. This information is provided in the assertion data described above.

The access-control service, that is the browser verifier 106 described above, inspects the request from the browser 102. If the request is determined to be from the required enterprise browser 102 but the request is issued from an automation tool 902 or from an embedder application, the login request is blocked and a blocked activity notification is displayed to the user. Information indicating the use of an automation tool 902 or embedder application can be found in the assertion data.

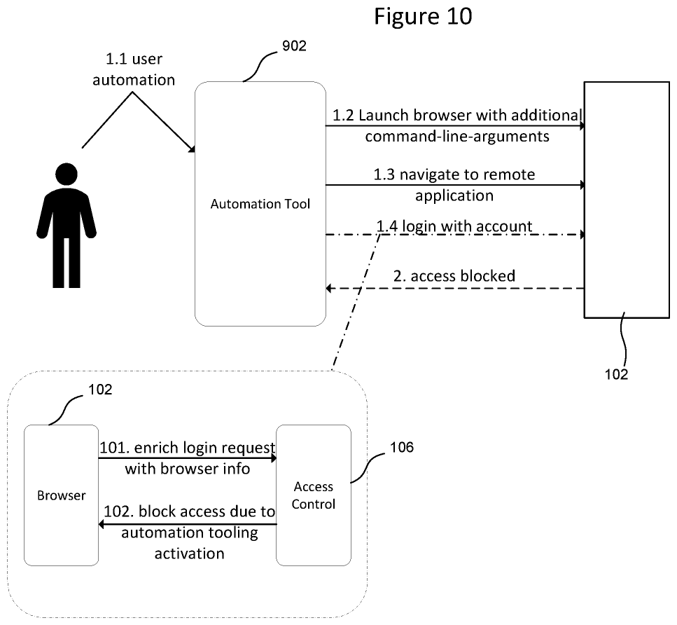

FIG. 10 provides an example method for rejecting a browser 102 driven by an automation tool 902 during the authentication phase. This prevents attacks in step 1 of FIG. 9.

Steps 1.1, 1.2, and 1.3 are as shown in FIG. 9.

Step 1.4 is modified to include steps 101 and 102. At step 101, the browser 102 provides information relating to the browser activation to the access controller (browser verifier) 106. This information is provide in the assertion in the methods described with reference to FIG. 2 and FIG. 3 above. The information relating to the browser activation indicates that the browser 102 was launched by an automation tool 902.

The access controller 106 determines is the browser 102 is running outside of the automation flow, based on the information relating to the browser activation. This step is performed before the browser 102 is returned to the application 108.

In the example of FIG. 10, the browser 102 is launched in the automation flow. Therefore, at step 102, the access controller 106 blocks assess to the application 108.

By blocking access to the remote application 108 in this way, the malicious user is not able to access any part of the application 108 and therefore cannot obtain sensitive information.

In some instances, automation may be activated by a malicious user after authentication has been executed. In other instances, some level of automation may be accepted. In these cases, it is desirable to provide a method for preventing the use of devtools, rather than prevent access to the remote application 108 entirely.

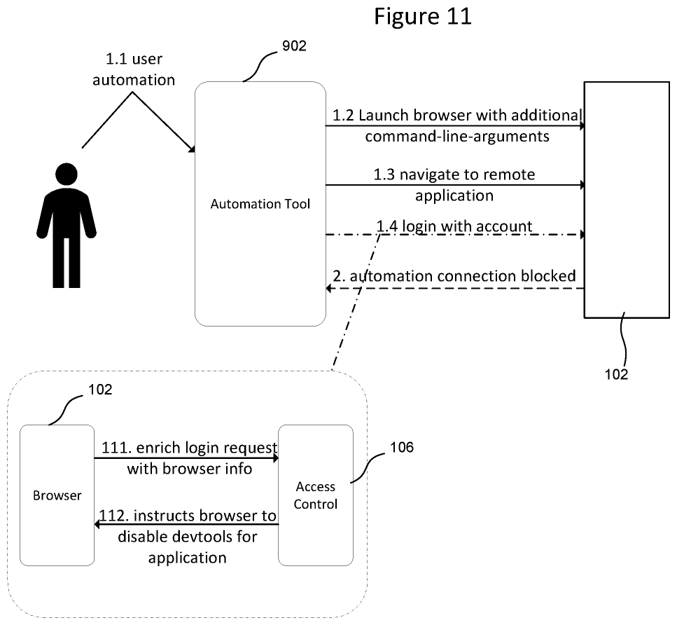

FIG. 11 provides an example method for preventing the use of devtools including exposing devtools protocol in the scope of protected applications. This prevents attacks in steps 2 and 3 of FIG. 9.

A browser 102 can turn on and off developer tools, and this activation/deactivation can be managed at tab level. That is, developer tools can be active in one browser tab, while deactivate in another.

As part of the authentication flow and before returning the browser 102 to the remote application 108, protected applications, or protected portions of the remote application 108, are identified and policies passed to the browser 102. This is a modification of step 1.4, as shown in FIG. 11. Here, at step 111, the browser 102 provides an enriched login request to the access controller 106 comprising the assertion data. The access controller 106, in response, instructs the browser 102 to disable the use of devtools for the application 108, step 112.

Thus, before the browser 102 navigates to the application 108, the policies are applied. When the user navigates to the application 108 via the browser 102, the user is not able to use the devtools.

The assertion is used to determine if the context of the browser 102 corresponds to the conditions required to execute the policies. For example, policies may only be applied to user profiles which are managed by the security service to which the verifier 102 belongs. Other conditions may apply, such as the browser 102 being in a public mode.

The actions of blocking access to the remote application 108, described with reference to FIG. 10, and disabling devtools, described with reference to FIG. 11, may be referred to as application limitation actions.

As described above, the assertion data is used to determine if the browser 102 is being executed in the context required to execute the policies. This context includes the browser not being launched in an automation flow, and criteria such as the profile being a managed profile. These criteria may be referred to as application environment criteria.

Security operators expect the ability to fine tune the policies based on the context to reduce their impact on users, administrators, and the operators themselves. To address these expectations, the security service maintains up-to-date contextual information and provides rich polices with context-based filters that allow pin-pointing actions to specific users, devices, applications, and the like.

The policies are normally based on significant, quickly changing, context that can include:
a. information on users such as group information, posture, and threat data;
b. Information on devices such as their security and management posture; and
c. Information on the connection details, e.g., location, ISP, IP Address.

Therefore, the methods set out above which require the browser 102 to provide such contextual information during authentication and before the user can access the remote application 108 allow the most relevant policies to be executed for the current context of the browser 102.

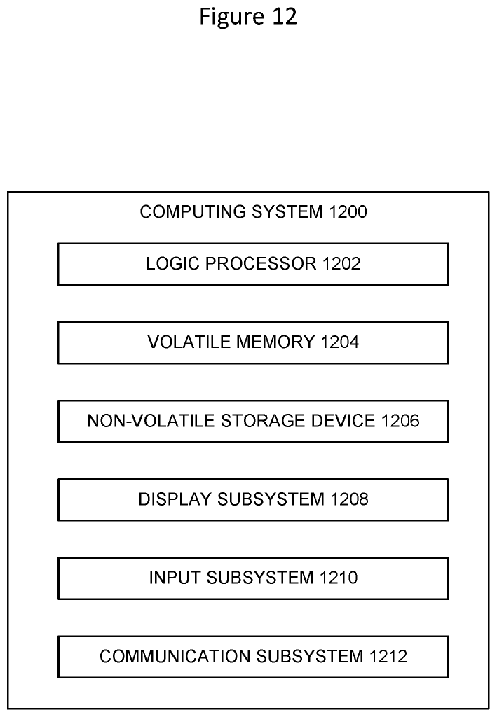

FIG. 12 schematically shows a non-limiting example of a computing system 1200, such as a computing device or system of connected computing devices, that can enact one or more of the methods or processes described above, including the filtering of data and implementation of the structured knowledge base described above. Computing system 1200 is shown in simplified form. Computing system 1200 includes a logic processor 1202, volatile memory 1204, and a non-volatile storage device 1206. Computing system 1200 may optionally include a display subsystem 608, input subsystem 1210, communication subsystem 1212, and/or other components not shown in FIG. 6. Logic processor 1202 comprises one or more physical (hardware) processors configured to carry out processing operations. For example, the logic processor 1202 may be configured to execute instructions that are part of one or more applications, programs, routines, libraries, objects, components, data structures, or other logical constructs. The logic processor 1202 may include one or more hardware processors configured to execute software instructions based on an instruction set architecture, such as a central processing unit (CPU), graphical processing unit (GPU) or other form of accelerator processor. Additionally or alternatively, the logic processor 1202 may include a hardware processor(s)) in the form of a logic circuit or firmware device configured to execute hardware-implemented logic (programmable or non-programmable) or firmware instructions. Processor(s) of the logic processor 1202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 1202 may be virtualized and executed by remotely accessible, networked computing devices configured in a cloud-computing configuration. In such a case, these virtualized aspects are run on different physical logic processors of various different machines. Non-volatile storage device 1206 includes one or more physical devices configured to hold instructions executable by the logic processor 1202 to implement the methods and processes described herein. When such methods and processes are implemented, the state of non-volatile storage device 1206 may be transformed—e.g., to hold different data. Non-volatile storage device 1206 may include physical devices that are removable and/or built-in. Non-volatile storage device 1206 may include optical memory (e.g., CD, DVD, HD-DVD, Blu-Ray Disc, etc.), semiconductor memory (e g., ROM, EPROM, EEPROM, FLASH memory, etc.), and/or magnetic memory (e.g., hard-disk drive), or other mass storage device technology. Non-volatile storage device 1206 may include nonvolatile, dynamic, static, read/write, read-only, sequential-access, location-addressable, file-addressable, and/or content-addressable devices. Volatile memory 1204 may include one or more physical devices that include random access memory. Volatile memory 1204 is typically utilized by logic processor 1202 to temporarily store information during processing of software instructions. Aspects of logic processor 1202, volatile memory 1204, and non-volatile storage device 1206 may be integrated together into one or more hardware-logic components. Such hardware-logic components may include field-programmable gate arrays (FPGAs), program-and application-specific integrated circuits (PASIC/ASICs), program- and application-specific standard products (PSSP/ASSPs), system-on-a-chip (SOC), and complex programmable logic devices (CPLDs), for example. The terms “module,” “program,” and “engine” may be used to describe an aspect of computing system 1200 typically implemented in software by a processor to perform a particular function using portions of volatile memory, which function involves transformative processing that specially configures the processor to perform the function. Thus, a module, program, or engine may be instantiated via logic processor 1202 executing instructions held by non-volatile storage device 1206, using portions of volatile memory 1204. Different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc. When included, display subsystem 1208 may be used to present a visual representation of data held by non-volatile storage device 1206. The visual representation may take the form of a graphical user interface (GUI). As the herein-described methods and processes change the data held by the non-volatile storage device, and thus transform the state of the non-volatile storage device, the state of display subsystem 1208 may likewise be transformed to visually represent changes in the underlying data. Display subsystem 1208 may include one or more display devices utilizing virtually any type of technology. Such display devices may be combined with logic processor 1202, volatile memory 1204, and/or non-volatile storage device 1206 in a shared enclosure, or such display devices may be peripheral display devices. When included, input subsystem 1210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. When included, communication subsystem 1212 may be configured to communicatively couple various computing devices described herein with each other, and with other devices. Communication subsystem 1212 may include wired and/or wireless communication devices compatible with one or more different communication protocols. As non-limiting examples, the communication subsystem may be configured for communication via a wireless telephone network, or a wired or wireless local-or wide-area network. In some embodiments, the communication subsystem may allow computing system 1200 to send and/or receive messages to and/or from other devices via a network such as the internet. The term computer readable media as used herein may include computer storage media. Computer storage media may include volatile and non-volatile, removable and nonremovable media (e.g., volatile memory 1204 or non-volatile storage 606) implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g. the computing system 1200 or a component device thereof). Computer storage media does not include a carrier wave or other propagated or modulated data signal. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct wired connection, and wireless media such as acoustic, radio frequency (RF), infrared, and other wireless media.

A first aspect herein provides a method for verifying an application structured to execute on a client device, the method comprising: sending, to the application, a challenge request; receiving, from the application in response to the challenge request, a candidate challenge answer; providing, as input to a verification computation, the candidate challenge answer and a challenge input; determining, based on an output of the verification computation, that the candidate challenge answer is generated by providing the challenge input to a challenge computation; and based on the determination that the candidate challenge answer is generated by providing the challenge input to the challenge computation, verifying the application.

In some embodiments, the application is structured to provide the challenge input to a challenge computation to generate the candidate challenge answer.

In some embodiments, the challenge input comprises challenge seed data, wherein the method further comprises: generating the challenge seed data; sending the challenge seed data to the application in the challenge request; storing the challenge seed data in a memory; and retrieving the challenge seed data from the memory in response to receiving the candidate challenge answer for providing as input to the verification computation.

In some embodiments, the challenge input comprises a challenge time, wherein the method further comprises: sending the challenge time to the application in the challenge request; storing the challenge time in a memory; and retrieving the challenge time from the memory in response to receiving the candidate challenge answer for providing as input to the verification computation.

In some embodiments, the candidate challenge answer is a candidate hash value, wherein the verification computation, when executed, is configured to: apply a hash function to the challenge input to generate a target hash value; and compare the target hash value to the candidate hash value to determine that the target hash value is equal to the candidate hash value; wherein it is determined that the candidate challenge answer is generated by providing the challenge input to the challenge computation based on the determination that the target hash value is equal to the candidate hash value.

In some embodiments, the challenge computation comprises the hash function.

In some embodiments, the candidate challenge answer comprises encrypted data, wherein the challenge input comprises assertion data, wherein the verification computation, when executed, is configured to: decrypt the candidate challenge answer using a decryption key to obtain candidate assertion data; and compare the candidate assertion data to the assertion data to determine that the candidate assertion data is equal to the assertion data; wherein it is determined that the candidate challenge answer is generated by providing the challenge input to the challenge computation based on the determination that the candidate assertion data is equal to the assertion data.

In some embodiments, the challenge computation comprises an encryption function, wherein the candidate challenge answer is generated by encryption the assertion data using an encryption key.

In some embodiments, the encryption key and the decryption key are symmetric keys.

In some embodiments, the decryption key is derivable based on challenge seed data, wherein the verification computation, when executed, is further configured to: compute the decryption key using the challenge seed data.

In some embodiments, the challenge input comprises the decryption key, wherein the decryption key is stored in a memory, wherein the method further comprises: in response to receiving the candidate challenge answer, obtaining the decryption key from the memory for providing as input to the verification computation.

In some embodiments, the challenge input comprises assertion data, wherein the method further comprises: receiving the assertion data from the application; and providing the assertion data as input to the verification computation.

In some embodiments, the method further comprises: determining, based on the assertion data, that an application environment criterion is met; wherein the application is further verified based on the determination that the application environment criterion is met.

In some embodiments, the method further comprises: determining, based on the assertion data, that an application environment criterion is not met; in response to determining that the application environment criterion is not met, executing an application limitation action (e.g., blocking access to the application, disabling devtools, etc.).

In some embodiments, the method further comprises, in response to verifying the application, granting access to a remote application.

A second aspect herein provides a method for generating a candidate challenge answer at an application executed on a client device, the method comprising: receiving, from a verifier, a challenge request; in response to the challenge request, providing a challenge input to a challenge computation to generate the candidate challenge answer; and providing the candidate challenge answer to the verifier; wherein the application is verifiable by providing, as input to a verification computation, the candidate challenge answer and the challenge input.

In some embodiments, the challenge input comprises assertion data, wherein the method further comprises: generating the assertion data for providing as input to the challenge computation; and providing the assertion data to the verifier.

In some embodiments, the challenge computation comprises a hash function, wherein the challenge computation is configured, when executed, to apply the hash function to the challenge input to generate a hash value, wherein the candidate challenge answer is the hash value.

In some embodiments, the challenge computation comprises an encryption function, wherein the challenge computation is configured, when executed, to encrypt assertion data using an encryption key, wherein the challenge input comprises the assertion data.

In some embodiments, the challenge input comprises challenge seed data, wherein the challenge computation comprise a key generation function, wherein the challenge computation is configured, when executed, to apply the key generation function to the seed data to generate the encryption key.

In some embodiments, the challenge request comprises the challenge seed data, wherein the method further comprises obtaining the challenge seed data from the challenge request for providing as input to the challenge computation.

In some embodiments, the encryption key is stored in a memory, wherein the method further comprises, in response to the challenge request, obtaining the encryption key from the memory for providing as input to the challenge computation.

In some embodiments, the application is an application for accessing a resource at a remote server.

In some embodiments, the application is a web browser for accessing a web application at the client device.

A third aspect herein provides a computer system comprising: at least one network interface; at least one memory configured to store computer-readable instructions of an application; and at least one processor coupled to the at least one network interface and the at least one memory, and configured to execute the computer-readable instructions, which are configured upon execution to cause the at least one processor to: receive, from a verifier, a challenge request; in response to the challenge request, provide a challenge input to a challenge computation to generate a candidate challenge answer; and provide the candidate challenge answer to the verifier; wherein the application is verifiable by providing, as input to a verification computation, the candidate challenge answer and the challenge input.

A fourth aspect herein provides a computer system comprising: at least one network interface; at least one memory configured to store computer-readable instructions; and at least one processor coupled to the at least one network interface and the at least one memory, and configured to execute the computer-readable instructions, which are configured upon execution to cause the at least one processor to: send, to an application structured to execute on a client device, a challenge request; receive, from the application in response to the challenge request, a candidate challenge answer; provide, as input to a verification computation, the candidate challenge answer and a challenge input; determine, based on an output of the verification computation, that the candidate challenge answer is generated by providing the challenge input to a challenge computation; and based on the determination that the candidate challenge answer is generated by providing the challenge input to the challenge computation, verify the application.

It will be appreciated that the above embodiments have been disclosed by way of example only. Other variants or use cases may become apparent to a person skilled in the art once given the disclosure herein. The scope of the present disclosure is not limited by the above-described embodiments, but only by the accompanying claim.

1. A method for verifying an application structured to execute on a client device, the method comprising:
sending, to the application, a challenge request;
receiving, from the application in response to the challenge request, a candidate challenge answer;
providing, as input to a verification computation, the candidate challenge answer and a challenge input;
determining, based on an output of the verification computation, that the candidate challenge answer is generated by providing the challenge input to a challenge computation; and
based on the determination that the candidate challenge answer is generated by providing the challenge input to the challenge computation, verifying the application.

2. The method of claim 1, wherein the challenge input comprises challenge seed data, wherein the method further comprises:
generating the challenge seed data;
sending the challenge seed data to the application in the challenge request;
storing the challenge seed data in a memory; and
retrieving the challenge seed data from the memory in response to receiving the candidate challenge answer for providing as input to the verification computation.

3. The method of claim 1, wherein the challenge input comprises a challenge time, wherein the method further comprises:
sending the challenge time to the application in the challenge request;
storing the challenge time in a memory; and
retrieving the challenge time from the memory in response to receiving the candidate challenge answer for providing as input to the verification computation.

4. The method of claim 1, wherein the candidate challenge answer is a candidate hash value, wherein the verification computation, when executed, is configured to:
apply a hash function to the challenge input to generate a target hash value; and
compare the target hash value to the candidate hash value to determine that the target hash value is equal to the candidate hash value;
wherein it is determined that the candidate challenge answer is generated by providing the challenge input to the challenge computation based on the determination that the target hash value is equal to the candidate hash value.

5. The method of claim 1, wherein the candidate challenge answer comprises encrypted data, wherein the challenge input comprise assertion data, wherein the verification computation, when executed, is configured to:
decrypt the candidate challenge answer using a decryption key to obtain candidate assertion data; and
compare the candidate assertion data to the assertion data to determine that the candidate assertion data is equal to the assertion data;
wherein it is determined that the candidate challenge answer is generated by providing the challenge input to the challenge computation based on the determination that the candidate assertion data is equal to the assertion data.

6. The method of claim 5, wherein the challenge input comprises challenge seed data, wherein the method further comprises:
generating the challenge seed data;
sending the challenge seed data to the application in the challenge request;
storing the challenge seed data in a memory; and
retrieving the challenge seed data from the memory in response to receiving the candidate challenge answer for providing as input to the verification computation;
wherein the decryption key is derivable based on challenge seed data, wherein the verification computation, when executed, is further configured to:
compute the decryption key using the challenge seed data.

7. The method of claim 5, wherein the challenge input comprises the decryption key, wherein the decryption key is stored in a memory, wherein the method further comprises:
in response to receiving the candidate challenge answer, obtaining the decryption key from the memory for providing as input to the verification computation.

8. The method of claim 1, wherein the challenge input comprises assertion data, wherein the method further comprises:
receiving the assertion data from the application; and
providing the assertion data as input to the verification computation.

9. The method of claim 8, wherein the method further comprises:
determining, based on the assertion data, that an application environment criterion is met;
wherein the application is further verified based on the determination that the application environment criterion is met.

10. The method of claim 8, wherein the method further comprises:
determining, based on the assertion data, that an application environment criterion is not met;
in response to determining that the application environment criterion is not met, executing an application limitation action.

11. The method of claim 1, wherein the method further comprises, in response to verifying the application, granting access to a remote application.

12. A method for generating a candidate challenge answer at an application executed on a client device, the method comprising:
receiving, from a verifier, a challenge request;
in response to the challenge request, providing a challenge input to a challenge computation to generate the candidate challenge answer; and
providing the candidate challenge answer to the verifier;
wherein the application is verifiable by providing, as input to a verification computation, the candidate challenge answer and the challenge input.

13. The method of claim 12, wherein the challenge input comprises assertion data, wherein the method further comprises:
generating the assertion data for providing as input to the challenge computation; and
providing the assertion data to the verifier.

14. The method of claim 12, wherein the challenge computation comprises a hash function, wherein the challenge computation is configured, when executed, to apply the hash function to the challenge input to generate a hash value, wherein the candidate challenge answer is the hah value.

15. The method of claim 12, wherein the challenge computation comprises an encryption function, wherein the challenge computation is configured, when executed, to encrypt assertion data using an encryption key, wherein the challenge input comprises the assertion data.

16. The method of claim 15, wherein the challenge input comprises challenge seed data, wherein the challenge computation comprise a key generation function, wherein the challenge computation is configured, when executed, to apply the key generation function to the seed data to generate the encryption key.

17. The method of claim 16, wherein the challenge request comprises the challenge seed data, wherein the method further comprises obtaining the challenge seed data from the challenge request for providing as input to the challenge computation.

18. The method of claim 15, wherein the encryption key is stored in a memory, wherein the method further comprises, in response to the challenge request, obtaining the encryption key from the memory for providing as input to the challenge computation.

19. The method of claim 12, wherein the application is an application for accessing a resource at a remote server.

20. A computer system comprising:
at least one network interface;
at least one memory configured to store computer-readable instructions; and
at least one processor coupled to the at least one network interface and the at least one memory, and configured to execute the computer-readable instructions, which are configured upon execution to cause the at least one processor to:
send, to an application structured to execute on a client device, a challenge request;
receive, from the application in response to the challenge request, a candidate challenge answer;
provide, as input to a verification computation, the candidate challenge answer and a challenge input;
determine, based on an output of the verification computation, that the candidate challenge answer is generated by providing the challenge input to a challenge computation; and
based on the determination that the candidate challenge answer is generated by providing the challenge input to the challenge computation, verify the application.
